(19) United States
(12) Patent Application Publication
(10) Pub. No.: US 2022/0340189 A1
(43) Pub. Date: Oct. 27, 2022

(54) SHOPPING CART HANDLE PROTECTOR

(71) Applicant: Roberta D. Erickson, Raymond (CA)

(72) Inventor: Roberta D. Erickson, Raymond (CA)

(21) Appl. No.: 17/239,546

(22) Filed: Apr. 24, 2021

(51) Int. Cl. B62B 5/06

(52) U.S. Cl. CPC B62B 5/069; B62B 3/14

(57) ABSTRACT

Illustrated views of an exemplary shopping cart handle protector for preventing disease, virus, grime and other pollutants contained on a handle of a shopping cart is presented. The shopping cart handle protector is useful for providing protection for hands of a person pushing a shopping cart from disease, virus, grime, etc. residing on the handle of the shopping cart. Furthermore, the shopping cart handle protector protects a child riding in the shopping cart from those pollutants when touching or placing their mouth on the handle of the shopping cart. The shopping cart handle protector is further washable, portable and cost efficient.

### FIELD OF THE INVENTION

This invention relates to shopping carts. More particularly, it relates to a device for protecting shopper from diseases found on a handle of the shopping cart.

### BACKGROUND

A shopping cart, also known by a variety of other names, is a wheeled cart supplied by a shop or store, especially supermarkets, for use by customers inside the premises for transport of merchandise as they move around the premises, while shopping, prior to heading to the checkout counter, cashiers or tills. Increasing the amount of goods a shopper can collect increases the quantities they are likely to purchase in a single trip, boosting store profitability.

In many cases customers can then also use the cart to transport theft purchased goods to their vehicles, but some carts are designed to prevent them from leaving either the store or the designated parking area by magnetically locking the wheels. Customers are encouraged to leave the carts in designated areas within the parking lot, and store employees will return the carts to the entrances. In some areas locking mechanisms are installed that are released by inserting coins or tokens are provided to encourage shoppers to return the carts to designated areas after use, at which time they get their coin or token back.

The ongoing COVID-19 pandemic was confirmed to have reached the United States in January 2020. The first confirmed case of local transmission was recorded in January, while the first known deaths happened in February. By the end of March, cases had occurred in all 50 U.S. states, the District of Columbia, and all inhabited U.S. territories except American Samoa. As of Jun. 24, 2020, the U.S. had the most confirmed active cases and deaths in the world. As of Jul. 16, 2020, its death rate was 419 per million people, the seventh-highest rate globally.

The Center for Disease Control (CDC) has issued a recommendation to the US population for prevention of contracting COVID 19 as well as other infectious diseases. Those recommendations are: 1) wash hands often; 2) avoid close contact (social distancing); 3) cover mouth and nose with a cloth face cover when around others; 4) cover cough or sneezes; 5) clean and disinfect; and 6) monitor your health daily.

Studies have shown that it is advisable for shoppers to sanitize the handles and basket areas prior to handling them or filling them with groceries due to high levels of bacteria that typically live on shopping carts. This is due to the carts having a high level of exposure to the skin flora of previous users.

More prevalent is the germs, bacteria, and virus' that can be left on a handle of a cart. Although shoppers have told to sanitize their carts, the handles are the most frequently missed. A spray of sanitizer or a sanitizing wipe are often hit and miss on the handle as well as potential affects on hands and palms of a shopper.

Accordingly, and in light of the foregoing, there is a need for a device that can be used to protect the hands of a shopper or their children in a seat of a cart. The device should also be reusable, washable and the shopper prevented from coming into contact with potential hazardous diseases.

### BRIEF DESCRIPTION OF THE DRAWINGS

FIGS. 1A and 1B are illustrated views of an exemplary shopping cart handle protector.

FIG. 2 is an illustrated view of exemplary magnets of the shopping cart handle protector shown in FIG. 1A.

FIG. 3 is an illustrated view of a shopping cart with the shopping cart hand protector shown in FIG. 1A.

### DETAILED DESCRIPTION

The phrases “in one embodiment,” “in various embodiments,” “in some embodiments,” and the like are used repeatedly. Such phrases do not necessarily refer to the same embodiment. The terms “comprising,” “having,” and “including” are synonymous, unless the context dictates otherwise. Such terms do not generally signify a closed list.

“Above,” “adhesive,” “affixing,” “any,” “around,” “both,” “bottom,” “by,” “comprising,” “consistent,” “customized,” “enclosing,” “friction,” “in,” “labeled,” “lower,” “magnetic,” “marked,” “new,” “nominal,” “not,” “of,” “other,” “outside,” “outwardly,” “particular,” “permanently,” “preventing,” “raised,” “respectively,” “reversibly,” “round,” “square,” “substantial,” “supporting,” “surrounded,” “surrounding,” “threaded,” “to,” “top,” “using,” “wherein,” “with,” or other such descriptors herein are used in their normal yes-or-no sense, not as terms of degree, unless context dictates otherwise.

Reference is now made in detail to the description of the embodiments as illustrated in the drawings. While embodiments are described in connection with the drawings and related descriptions, there is no intent to limit the scope to the embodiments disclosed herein. On the contrary, the intent is to cover all alternatives, modifications and equivalents. In alternate embodiments, additional devices, or combinations of illustrated devices, may be added to, or combined, without limiting the scope to the embodiments disclosed herein.

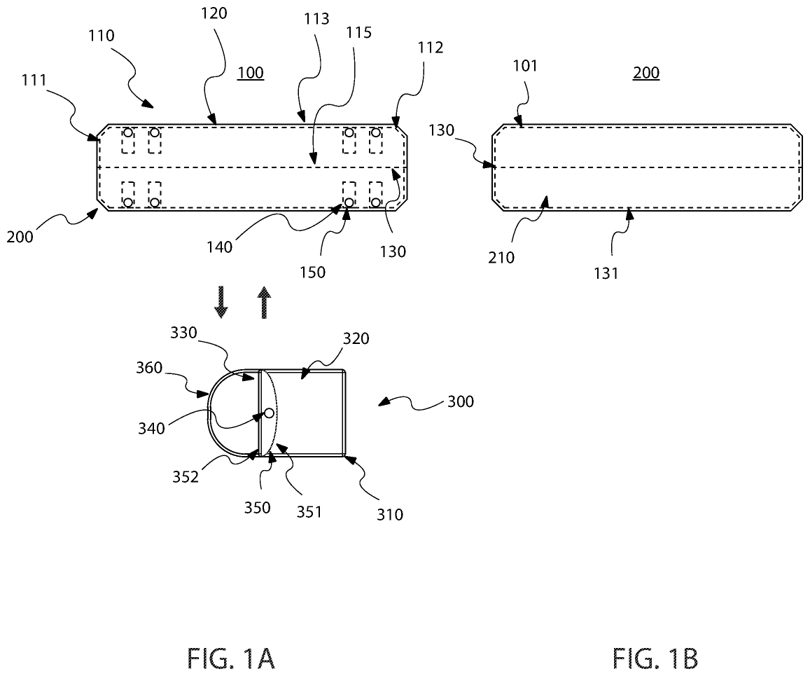

Referring to FIG. 1A and FIG. 1B, illustrated views of an exemplary shopping cart handle protector 100 for preventing a spread of disease, virus' and/or bacteria contained on a handle of a shopping cart is presented. The shopping cart handle protector 100 is useful for providing protection for hands of a person pushing a shopping cart from disease, virus, grim, etc. residing on the handle of the shopping cart. Furthermore, the shopping cart handle protector 100 protects a child riding in the shopping cart from those pollutants when touching or placing their mouth on the handle of the shopping cart. The shopping art handle protector 100 is further washable, portable and cost efficient.

The shopping cart protector 100 has a body 110 and a storage device 300. The body 110 of the shopping cart protector 100 preferably is made of a fabric material, such as denim, however other materials are hereby contemplated, including, but not limited to, plastic, cotton, nylon, etc. The body 110 of the shopping cart handle protector 100 preferably has a length of sixteen (16) inches, however other lengths are hereby contemplated, including, but not limited to, fourteen (14) inches, seventeen (17) inches, etc. The shopping cart handle protector 100 preferably has a width of eight (8) inches, however other widths are hereby contemplated, including, but not limited to, six (6) inches, ten (10) inches, etc.

The body 110 has a top 120, a bottom 200, and a plurality of first magnets 150. The body further has a seam 111. The seam 111 allows for a pocket 112. The seam 111 is substantially near the outer edge 113 of the body 110.

The body 110 further has a folding crease 130. The folding crease 130 allows the body 110 to be creased at a central point 115 thereby allowing for the body 110 to be wrapped around a handle of a shopping cart, as will be described in FIG. 3.

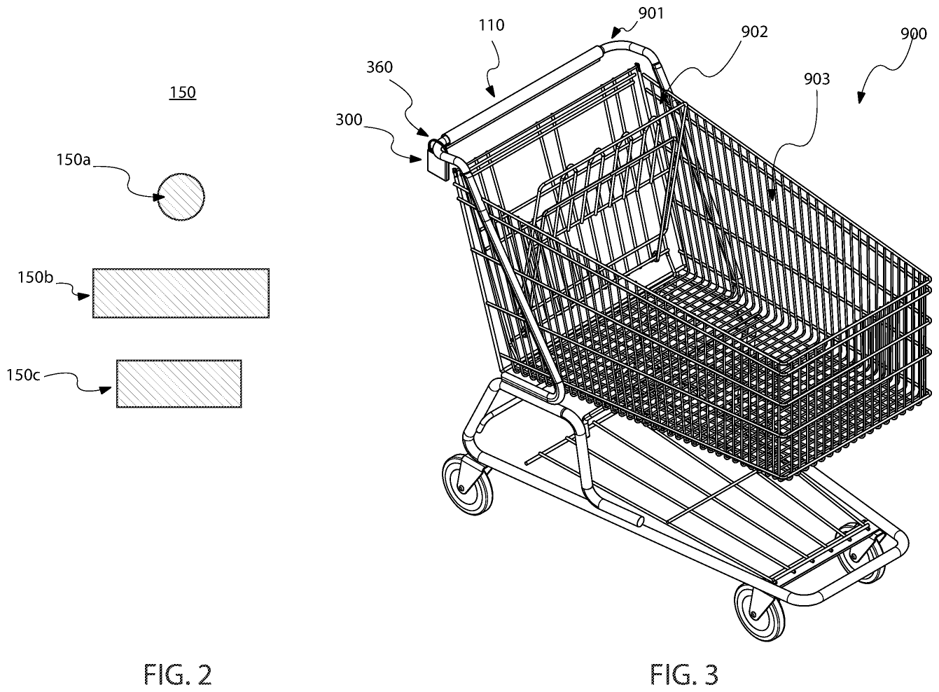

The first magnets 150 are preferably four (4) in number, however other number of magnets are hereby contemplated, including, one (1), two (2) six (6), etc. The number of first magnets 150 is dependent on the size and type of first magnets 150 being utilized. In FIG. 2, exemplary types of magnet sizes are presented. The sizes of the first magnets 150 may be, however not limited to, a button magnet 150a, a long rectangular magnet 150b, a short square magnet 150c, etc.

The first magnets 150 have a magnet holder 140. The magnet holder 140 is preferably a pouch, however other types of holders are hereby contemplated, including, but not limited to, two-sided tape, the pocket 112 formed by the seam 111, etc. The magnets 120 are preferably removable, however, it is contemplated that the first magnets 150 are permanently attached to the magnet holder 140 coupled to the body 110.

FIG. 1B presents the back 200 of the body 110 of the shopping cart handle protector 100. The body 110 has the seam 130 and the folding crease 130. Optionally, and/or additionally, an inside 131 of the seam 130 of the body 110 has a protective cover 210 to add a protective layer from the handle of the shopping cart. The protective cover 210 is preferably made of a vinyl material, however other materials are hereby contemplated, including, but not limited to, rubber, nylon, etc.

Returning to FIG. 1A, the storage device 300 has a first end 330, a top 310 and an inside 320. The first end 330 has cover 350. The cover 350 opens and closes to allow or disallow access to the inside 320 of the storage device 300.

The cover 350 has an inside 351 and an outside 352. A closure 340 is coupled to the inside 351 of the cover 350 and is configured to prevent the cover 350 from opening when in transport.

Furthermore, a handle 360 is coupled to the top 330 of the storage device 300. The handle 360 is useful for transporting the storage device 300 when the body 110 has been placed inside 351 of the storage device 300. The handle 360 may also be coupled to near the handle of the shopping cart when the body 110 has been configured to be coupled to the handle of the shopping cart.

Moving now to FIG. 3, a handle 901 of a shopping cart 900 configured with the body 110 of the shopping cart handle protector 100 is presented.

The shopping cart 900 has the handle 901, a basket 903 and a movable seat 902. The seat 902 of the shopping cart 900 is configured to have a child sitting in the seat 902 to face and hold onto the handle 901 of the shopping cart 900.

The body 110 of the shopping cart handle protector 100 is configured to be fitted around the handle 901 of the shopping cart 900. The body 110 of the shopping cart handle protector 100 protects the hands of the person pushing the shopping cart 900 from coming into contacts and carry any disease, virus, grim, etc. residing on the handle 901 of the shopping cart 900 from be carried to other parts of the person or other person. The body 110 of the shopping cart handle protector 100 further protects the child in the seat 902 of the shopping cart 900 from coming into direct contact with the handle and thus preventing the spread of disease or virus. The child's hands are therefore protected as well as the mouth area if the child were to place their mouth on the handle 901 of the shopping cart 900 as some children do from time to time.

Storage of the storage device 300 is presented. The handle 560 of the storage device 300 is removably coupled to the handle 901 of the shopping cart 900.

In the numbered clauses below, specific combinations of aspects and embodiments are articulated in a shorthand form such that (1) according to respective embodiments, for each instance in which a “component” or other such identifiers appear to be introduced (with “a” or “an,” e.g.) more than once in a given chain of clauses, such designations may either identify the same entity or distinct entities; and (2) what might be called “dependent” clauses below may or may not incorporate, in respective embodiments, the features of “independent” clauses to which they refer or other features described above.

Those skilled in the art will appreciate that the foregoing specific exemplary processes and/or devices and/or technologies are representative of more general processes and/or devices and/or technologies taught elsewhere herein, such as in the claims filed herewith and/or elsewhere in the present application.

The features described with respect to one embodiment may be applied to other embodiments or combined with or interchanged with the features of other embodiments, as appropriate, without departing from the scope of the present invention.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A shopping cart handle protector device for preventing a spread of disease, virus' and/or bacteria contained on a handle of a shopping cart, the device comprising:
a body, the body having a top and a bottom;
the top having a seam and a folding crease, the seam being significantly near an outer edge of the body, wherein the seam being configured to form a pocket, wherein the folding crease being in a central point of the body, and wherein the folding crease being configured to allow the body to be securely wrapped around the handle of the shopping cart;
the bottom having the seam, the folding crease, the seam having an inside;
a plurality of first magnets, wherein the first magnets being coupled to the body by a magnet holder;
a storage device, the storage device having outside, a top and an inside, wherein the inside of the storage device being configured to hold the body of the device;
a cover, the cover being coupled to the top of the storage device, wherein the cover having an inside and an outside, the cover being configured to open to allow access to the inside of the storage device;
a closure, the closure being coupled to the inside of the cover, the closure being for prevention of the cover from opening when in transport; and
a handle, the handle being coupled to the top of the storage device, wherein the handle being configured to facilitate portability of the storage device.

2. The device of claim 1, wherein the body being made of a fabric material.

3. The device of claim 2, wherein the fabric material being denim.

4. The device of claim 1, wherein the body having a length being sixteen (16) inches.

5. The device of claim 1, wherein the body having a width being eight (8) inches.

6. The device of claim 1, wherein the first magnets being four (4) in number.

7. The device of claim 1, wherein the first magnets having round shape.

8. The device of claim 1, wherein the first magnets having a rectangular shape.

9. The device of claim 1, wherein the first magnets having a square shape.

10. The device of claim 1, wherein the magnet holders being a pouch.

11. The device of claim 1, wherein the magnet holder being the pocket formed by the seam.

12. The device of claim 1, wherein the back having a protective cover, wherein the protective cover being coupled to the back on the inside of the seam.

13. The device of claim 12, wherein the protective cover being made of a plastic material.

14. The device of claim 12, wherein the protective cover being made of a rubber material.
